(19) United States
(12) Patent Application Publication
(10) Pub. No.: US 2023/0356120 A1
(43) Pub. Date: Nov. 9, 2023

(54) FILTER BAG AND FILTER MODULE FOR A ROTARY DISK FILTER AND ROTARY DISK FILTER

(71) Applicant: HUBER SE, Berching (DE)

(72) Inventors: Thomas Kerl, Muehlhausen (DE); Winfried Regnat, Berching (DE)

(21) Appl. No.: 18/311,286

(22) Filed: May 3, 2023

(30) Foreign Application Priority Data
May 3, 2022 (DE) 10 2022 110 830.9

(51) Int. Cl. B01D 33/23; B01D 33/39

(52) U.S. Cl. CPC B01D 33/23; B01D 33/39; B01D 2201/0415

(57) ABSTRACT

A filter bag for a rotary disk filter, which is used to filter wastewater, has a filter material with a mounting opening, via which the filter bag can be slipped over a support frame of the rotary disk filter during a mounting step in order to form a filter module. The filter material has an exit opening that is situated opposite the mounting opening and allows filtrate to exit the interior of the filter module into a central pipe of the rotary disk filter. A reinforcement is connected to the filter material at an edge delimiting the mounting opening and fixes the filter bag at the support frame. A filter module and a rotary disk filter are disclosed.

### FIELD OF THE INVENTION

The present invention relates to a filter bag for a rotary disk filter, which is used to filter wastewater, wherein the filter bag has a filter material with a mounting opening, via which the filter bag can be slipped over a support frame of the rotary disk filter during a mounting step in order to form a filter module. The present invention also relates to a rotary disk filter a rotary disk filter that includes a central pipe and multiple filter disks, which are arranged adjacent to one another in the longitudinal direction of the central pipe and are connected to a central pipe, wherein each filter disk includes multiple filter modules, which are arranged adjacent to one another in the circumferential direction of the central pipe. The present invention also relates to a filter module of the filter disk.

### BACKGROUND OF THE INVENTION

A rotary disk filter of the type in question is known, for example, from DE 39 26 962 A1. Corresponding rotary disk filters—and this also applies for the rotary disk filter according to the present invention—are utilized, for example, for removing solids from wastewater.

In principle, a rotary disk filter includes a receptacle, in which the individual filter disks are arranged, adjacent to one another, on the central pipe. The central pipe is drivable about its longitudinal axis with the aid of a drive and together with the individual filter disks. If the wastewater to be treated is now guided into the receptacle, the wastewater flows from the outside through the filtration area of the individual filter modules, of which the individual filter disks are composed, into the interior of the filter modules and, from there, into the central pipe. Solids present in the wastewater are retained by the filtration area of the filter modules, wherein the efficiency of the removal of the solids depends on the properties of the filtration area. The filtrate entering the central pipe is finally discharged from the rotary disk filter.

It is also already known to implement the filtration area in the form of a filter cloth, which is sack-shaped and, during the manufacture of the particular filter module, is slipped over a support frame of the filter module and subsequently fixed at the support frame by clamping.

The disadvantage of this approach is that the filter cloth can slip with respect to the support frame during the operation of the rotary disk filter, and so, in the least favorable case, wastewater passes by the filtration area, enters the interior of the filter modules, and finally contaminates the filtrate that has already been obtained.

### OBJECTS AND SUMMARY OF THE INVENTION

The problem addressed by the present invention is that of enhancing the described prior art.

The problem is solved by a filter bag, a filter module, and a rotary disk filter having the features described below.

The invention initially relates to a filter bag for a rotary disk filter, which is used to filter wastewater, wherein the filter bag is formed of a filter material that defines a hollow interior that is accessible via a mounting opening, via which the filter bag can be slipped over a support frame of the rotary disk filter during a mounting step. The mounting opening is a slit or any other discontinuity in the filter material, the dimensions of which are sized such that the support frame can be slid via the mounting opening into the interior of the filter bag (alternatively, the filter bag can also be pulled over the support frame). After the filter bag has been pulled onto the support frame, which is preferably made of plastic, or after the support frame has been slid into the filter bag, the filter bag roughly has the shape of the support frame, wherein the support frame in turn preferably has a trapezoidal basic shape. The individual sides of the trapezoidal shape do not necessarily need to be straight. For example, it is also conceivable that the side resting against a central pipe of a rotary disk filter during the use of the filter modules as intended (support frame with filter bag pulled over) and/or the side situated on the outside relative to the central pipe have/has the shape of a circular arc.

The filter material also has one or multiple exit opening(s), which is/are preferably situated opposite the mounting opening and, when the filter bag is used as intended, enable(s) filtrate to exit the interior of the filter module into a central pipe of the rotary disk filter once the filter module has been connected to the central pipe. During the operation of the rotary disk filter, wastewater therefore flows from the outside via the filter bag into the interior of the particular filter module, wherein solids up to a certain size are retained by the filter bag.

If the filter bag had been merely pulled over the support frame and the resultant filter module connected to a central pipe of a rotary disk filter, there would be a risk that the filter bag would slip with respect to the support frame. It has already been provided to fix the filter bag with respect to the support frame at selected points by clamping. The filter bag is generally a cloth-like material, however, which has no or only very little inherent stability. If forces now act upon the filter bag due to the rotation of the individual filter disks of the rotary disk filter (each of which includes multiple filter modules distributed around a central pipe), there is a risk that the filter bag will slip with respect to the support frame during the operation of the rotary disk filter. In order to prevent this from happening, it is now provided according to the invention to arrange a reinforcement in the area of an edge delimiting the mounting opening, the reinforcement being used to fix the filter bag at the support frame.

The reinforcement is a section of the filter bag including the reinforcement, which differs from the rest of the filter bag with respect to its material, its material thickness (more particularly its thickness), its material composition, or any other properties. For example, it would be conceivable that the filter bag has a greater material thickness in the area of the aforementioned edge than the majority of the remaining filter bag. Due to the greater material thickness, the filter bag can be more reliably fixed in this area, wherein the fixation can be carried out, for example, by clamping the edge between a first section of the support frame and a further section of the support frame, which is situated opposite the first section relative to the edge, wherein the further section can also be formed by a separate clamping bar (as described in the following).

For example, it would be conceivable that the filter bag is folded over multiple times and subsequently stitched in the area of its edge during the manufacture of the filter bag such that a reinforced edge arises. It is also conceivable, as is moreover described in greater detail, that one or multiple element(s) in the area of the edge is/are connected to the filter bag or fixed or enclosed by the filter bag, wherein the element(s) act(s) as reinforcement and ensure(s) a reliable fixation of the filter bag with respect to the support frame.

The filter bag according to the invention therefore includes a sack- or tube-like filter material into which a support frame can be slid via a mounting opening. In the area of the mounting opening, the filter bag has a property (for example, material type or material thickness or material composition), which deviates from the property in the area of the actual filtration area. The deviation is selected such that an area arises in the area of the edge surrounding the mounting opening, which is reinforced as compared to the area of the filtration area through which wastewater subsequently flows.

Moreover, it is advantageous when the filter material is formed as a pile cloth. A pile cloth is a woven fabric in which pile threads are fixedly integrated on a preferably textile base fabric, as a result of which a three-dimensional structure arises. The solids carried along in the wastewater to be filtered are retained by this pile cloth, while the purified water enters the interior of the particular filter module and can be discharged via the central pipe, which is connected to the filter module.

It is also advantageous when the mounting opening is formed essentially in the shape of a slit. “In the shape of a slit” means, in the present case, that the mounting opening has a shape, the length of which corresponds at the least to two times, preferably three times the width of the mounting opening, which extends perpendicularly to the length. More particularly, the mounting opening should have a shape and appropriate dimensions that make it possible to insert the entire support frame into the interior of the filter bag during the assembly of the filter module, which includes the filter bag. Preferably, the reinforcement according to the invention surrounds the mounting opening completely or up to at least 70%, preferably up to at least 80%.

It is also advantageous when the reinforcement is formed by at least one elongate, preferably cable-shaped profile, for example, a wire, wherein the reinforcement is made more particularly of metal and/or plastic. The filter bag includes a tubular section preferably in the area of the reinforcement, in which the reinforcement is integrated. For example, the tubular section can have been manufactured by the filter material having been folded over and appropriately stitched in the area of the edge delimiting the mounting opening during the manufacture of the filter bag. It is also conceivable that the reinforcement is woven directly into the filter material or bonded with the filter material.

It is also advantageous when the reinforcement is connected to the filter material with the aid of one or multiple seam(s). The reinforcement is preferably surrounded by the filter material, wherein the seam or the seams penetrate(s) or merely surround the reinforcement.

It is also advantageous when the reinforcement is at least partially encased in the filter material, for example, by a tube-like section of the filter bag, more particularly by a tube-like section of the filter material. The tube-like section of the filter material can be manufactured by folding over the filter material. The filter material can also be connected to an additional section, which forms the tube-like section and is part of the filter bag.

It is also advantageous when the filter bag has a seal in the area of the exit opening, via which the filter bag sealingly rests against a central pipe of the rotary disk filter during use as intended. As described above, the filter bag is slipped over a support frame during a mounting step, in order to form a filter module in this way. The filter module is finally connected to a central pipe of a rotary disk filter, i.e., there is a joining surface between the filter module and the central pipe. In order to prevent unfiltered wastewater from entering the central pipe in this area, it is advantageous when the aforementioned seal is present. The seal can be, for example, a rubber profile, which surrounds the exit opening in the area of an outer side of the filter bag and is bonded or stitched to the filter material.

Moreover, the invention relates to a filter module for a rotary disk filter, wherein the filter module has a support frame and a filter bag, which encloses the support frame at least in sections. According to the invention, it is provided that the filter bag has one or more of the features described above and/or in the following. The support frame preferably has an essentially trapezoidal shape, wherein one or more side(s) of the trapezoidal shape can also be curved, preferably in the shape of a circular arc. The filter bag encompasses the support frame nearly completely or entirely. Moreover, the support frame includes one or multiple hollow space(s) into which filtrate can flow, from outside to inside, during the operation of the rotary disk filter. Moreover, the support frame includes at least one opening, via which the filtrate, which has flowed in, can enter a central pipe of the rotary disk filter, to which the filter module is connected during use as intended.

More particularly, it is advantageous when the filter module includes a clamping bar (preferably made of plastic), with the aid of which the filter bag is pressed in the area of its mounting opening against the support frame and, due to the clamping effect that is induced as a result, is fixed at the support frame. The clamping bar is designed such that the clamping bar completely overlaps and, therefore, closes the mounting opening. This ensures that none of the solids carried along by the wastewater can enter the interior of the filter module via the mounting opening, i.e., unfiltered. The filter material is preferably folded over an outer edge of the support frame in the area of the mounting opening and overlaps the support frame. In addition, the reinforcement of the edge of the filter material is located between the support frame and the clamping bar such that the reinforcement is clamped due to the interplay of the clamping bar and the support frame and, therefore, is securely fixed. The clamping bar is preferably connected to the support frame with the aid of one or multiple screw(s). Alternatively, it is also conceivable that the reinforcement is located adjacent to the clamping bar and prevents the filter material from being pulled out of the clamping area.

It is also advantageous when the support frame is composed of two, preferably mirror symmetrical, half shells. Both half shells preferably have the above-described trapezoidal shape (preferably having two circular arc-shaped base sides and two straight limbs).

It is particularly advantageous when the clamping bar has projections, more particularly in the form of bolts, which engage into corresponding holding fixtures of both half shells and preferably penetrate the filter material. The bolts engage into the holding fixtures of both half shells like clamps and, thereby, effectuate a connection and spatial alignment of both half shells. The two half shells can, for example, be additionally screwed or bonded together or connected to each other in a form-locking manner via latching mechanisms. It is also advantageous when the two half shells include spacer bolts, which keep the half shells at a distance from one another after having been connected, and so an interior hollow space is present, into which the filtrate can flow during the use of the filter module as intended. Due to the interplay of the bolts and the holding fixtures, it is finally ensured that the two half shells remain correctly located with respect to one another.

It is particularly advantageous when the support frame and/or the clamping bar have/has an uneven surface, preferably a ribbing, which is in contact with the filter bag in order to intensify the clamping effect of the clamping bar in comparison to an even surface. In the fully assembled condition of the filter module, the uneven surface is in contact with the reinforcement or with the material of the filter bag surrounding the reinforcement. It is also conceivable that the uneven surface is located between the reinforcement and the section of the filter bag forming the actual filtration area of the filter module. The reinforcement would therefore first have to pass the uneven surface before becoming disengaged from the clamping bar. An inadvertent detachment of the filter bag is therefore nearly ruled out.

It is advantageous when the support frame has a plurality of honeycomb-shaped openings, through which the filtrate passing through the filter material can flow into the interior of the filter module. Individual bores or slits are also conceivable, of course, which enable the desired flow of filtrate.

Moreover, it is advantageous when the support frame includes retaining extensions, more particularly in the form of hooks, which engage into or extend through holes or tabs of the filter bag. The holes or tabs are preferably located in the area of the edge surrounding the mounting opening or are located at most 1 cm to 5 cm away from the area of the edge surrounding the mounting opening. If the support frame is now placed into the filter bag, the retaining extensions extend through the corresponding holes or tabs. As a result, the filter bag is already fixed and aligned with respect to the support frame, and so the subsequent fixation by means of the clamping bar is simplified. Additionally or alternatively, it is advantageous when one or multiple hole(s) or tab(s) is/are also present in the area of the exit opening(s) of the filter bag. In this case, the support frame should have appropriate retaining extensions in the area in which the aforementioned holes or tabs are located once the support frame has been slid into the filter bag. The interplay of the retaining extensions with the holes or tabs ensures that the filter bag does not slip in the area of the exit opening before the filter module is connected to the central pipe. Preferably, the filter bag, after having been connected to the central pipe, is retained via clamping between the central pipe and the support frame.

The rotary disk filter according to the invention includes a central pipe, which is driven with the aid of a drive, and multiple filter disks, which are arranged adjacent to one another in the longitudinal direction of the central pipe and are connected to the central pipe, wherein each filter disk includes multiple filter modules, which are arranged adjacent to one another in the circumferential direction of the central pipe. According to the invention, it is provided that the filter modules are designed as described above and/or in the following. Preferably, the individual filter modules include a rod, which penetrates the particular filter module in a radial direction of the filter disks and is connected to the central pipe. The rod also penetrates the filter module on the opposite side of the central pipe. Finally, the filter module is pulled against the central pipe and, thereby, fixed with respect to the central pipe with the aid of a nut.

It is also advantageous when the central pipe has openings, via which the filtrate can flow from the filter modules into the interior of the central pipe, wherein each filter module has retaining extensions, each of which protrudes into the opening associated with the filter module and prevents the filter module from slipping with respect to the central pipe. The filter modules are therefore form-lockingly fixed in the area of the central pipe.

### BRIEF DESCRIPTION OF THE DRAWINGS

Further advantages of the invention are described in the following exemplary embodiments, wherein, schematically:

FIG. 1 shows from a perspective viewpoint, filter modules of an embodiment of the invention mounted on a central pipe,

FIG. 2 shows from a perspective viewpoint, a support frame and a clamping bar of a filter module according to an embodiment of the invention,

FIG. 3 shows from a perspective viewpoint, a filter bag according to an embodiment of the invention,

FIG. 4a shows in a planar view looking toward the interior of a filter module according to an embodiment of the invention before the clamping bar is installed,

FIG. 4b shows in a planar view like shown in FIG. 4a, a filter module according to an embodiment of the invention after the clamping bar has been installed,

FIG. 5 shows in a sectional representation cut from FIG. 4b and sighted in the direction of arrows A--A, a filter module according to an embodiment of the invention in the vicinity of the clamping bar, and

FIG. 6 shows in a planar view looking toward the interior of a filter module according to an embodiment of the invention as viewed from the side that is connected to the central pipe after assembly.

### DETAILED DESCRIPTION OF EXEMPLARY EMBODIMENTS

In the following figures, elements and components of the same kind are identically represented and, therefore, in some cases only one of multiple elements or components of the same kind is labeled with a reference character in order to ensure a best possible overview.

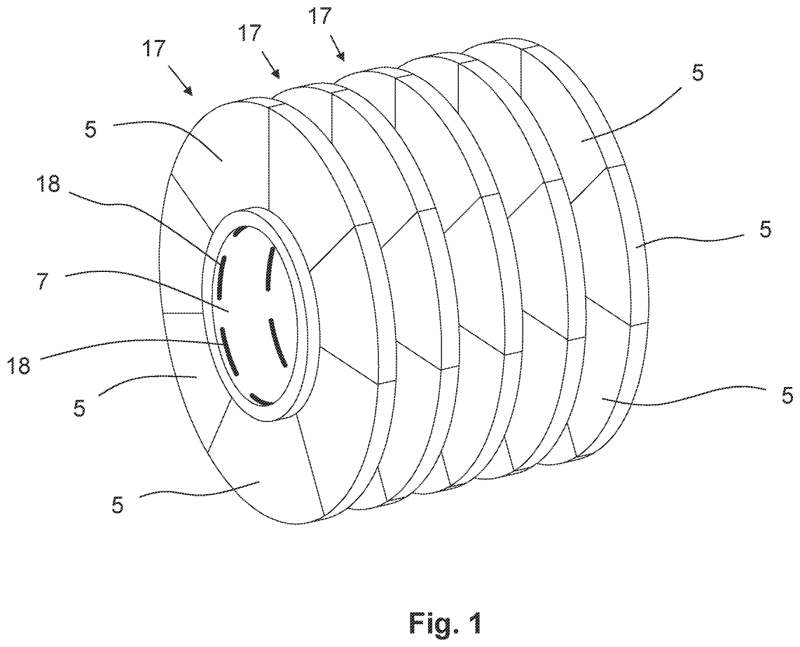

FIG. 1 shows a central pipe 7 of a rotary disk filter, which includes multiple filter modules 5 secured at the central pipe 7. Several of the filter modules 5 form one filter disk 17 in each case. The components shown are located in a closed receptacle (not shown) during use as intended, the receptacle being used to accommodate wastewater to be filtered. The wastewater flows through the filter disks 17 from outside to inside, wherein solids up to a certain particle size, which is also dependent on the type of filter bag 1 described in the following, are retained. The filtrate passing through the filter bag 1 finally reaches the interior of the central pipe 7 via openings 18 and can be discharged from the rotary disk filter via a filtrate outlet (not shown).

The configuration of the individual filter modules 5 is described in greater detail in the following.

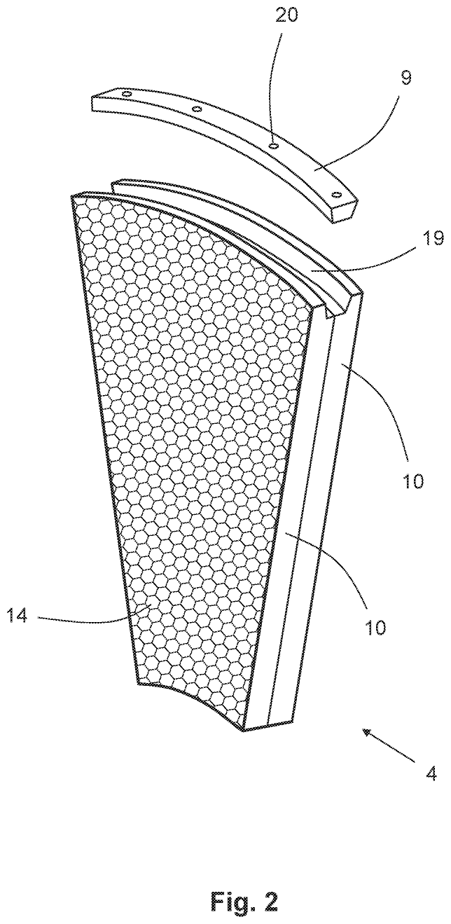

Each of the filter modules 5 has a support frame 4, which is situated in the interior during use as intended and preferably includes two half shells 10, which are connected to each other as shown in FIG. 2. The half shells 10 in turn have individual, for example, honeycomb-shaped openings 14 (see FIG. 2), via which filtrate can flow from the outside into the interior of the support frame 4 and, finally, via an outlet opening in the support frame 4 into the interior of the central pipe 7.

Moreover, the filtrate module 5 includes a clamping bar 9 for fixing a filter bag 1, which has not yet been connected to the support frame 4 in the view in FIG. 2. As is clear from FIG. 2, one end of the support frame 4 is configured with a groove 19, which essentially corresponds to the negative shape of the clamping bar 9.

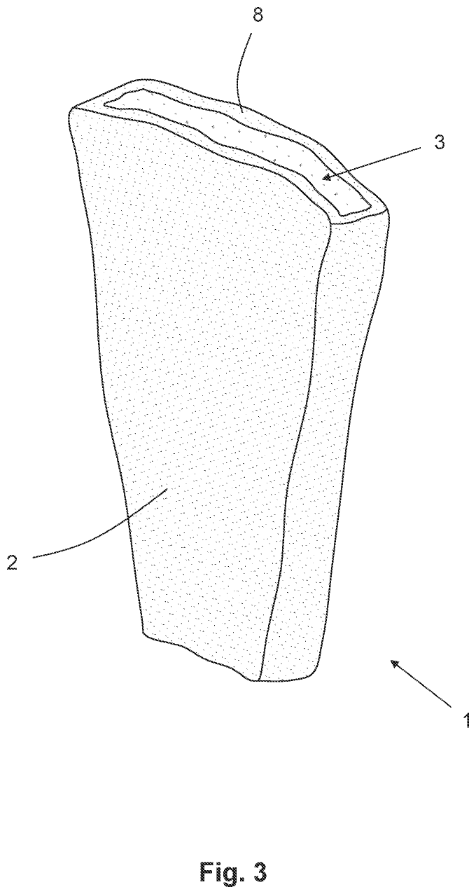

FIG. 3 shows a filter bag 1 according to an exemplary embodiment of the invention. The filter bag 1 is made essentially of a filter material 2 having a defined mesh width, and so solids that are carried along by wastewater to be filtered and have at least a certain particle size are retained by the filter material 2. The filter bag 1 essentially has a shape that corresponds to the shape of the support frame 4.

Moreover, a mounting opening 3 is provided at one end of the filter bag 1, into which the support frame 4 (with respect to FIG. 3, above) can be slid into the filter bag 1 (the filter bag 1 can also be pulled over the support frame 4, of course). The mounting opening 3 therefore has a cross-section that is designed to be large enough for the support frame 4 to be positioned within the filter bag 1. Preferably, the filter material 2 is formed as pile cloth.

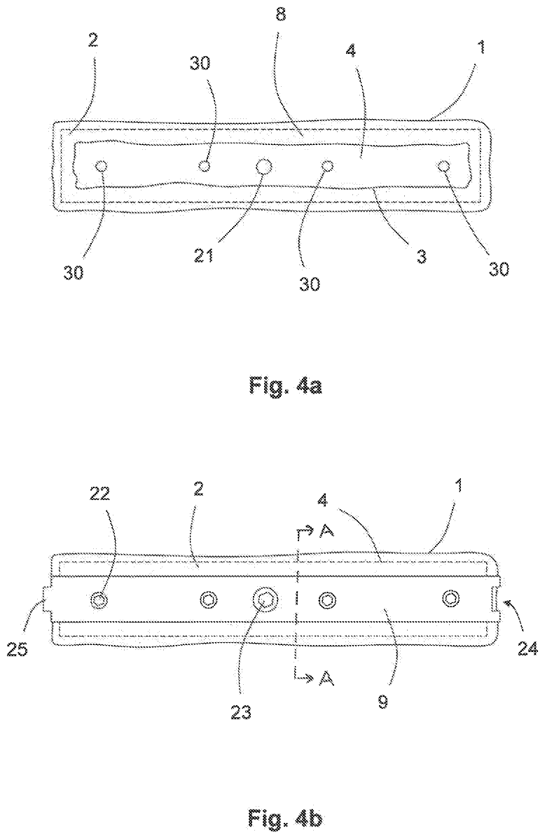

In FIG. 4a, a support frame 4 is shown in a planar view from above (i.e., from the side facing away from the central pipe 7) and without the clamping bar 9, after the filter bag 1 has been pulled over the support frame 4 or the support frame 4 has been inserted into the filter bag 1. The filter material 2 is either so flexible that the support frame 4 can be moved through the mounting opening 3. Or, it is conceivable that the filter bag 1 has individual incisions (not shown) in the area of the mounting opening 3, thereby enabling the aforementioned insertion.

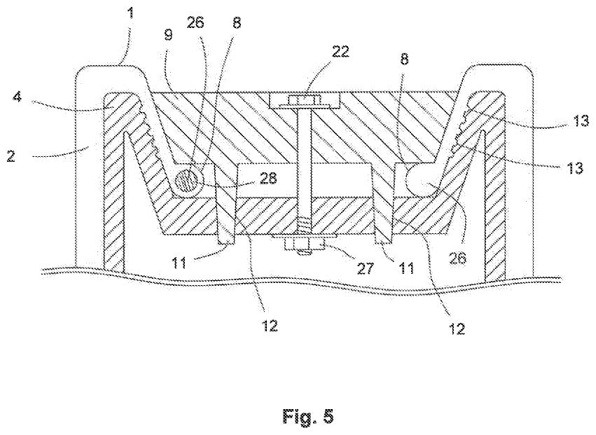

Once the filter bag 1 and the support frame 4 have been aligned as shown in FIG. 4a, the clamping bar 9 is connected to the support frame 4, wherein as schematically shown in FIG. 4b this connection can be carried out, for example, with the aid of screws 22, which are inserted through bores 20 (see FIG. 2) defined through the clamping bar 9 and screwed, for example, into a corresponding threaded hole 30 defined in the support frame 4 (see FIG. 4a). Alternatively, the hole 30 need not be threaded, and the end of the screw 22 can be threaded into a correspondingly threaded nut 27 as schematically shown in FIG. 5.

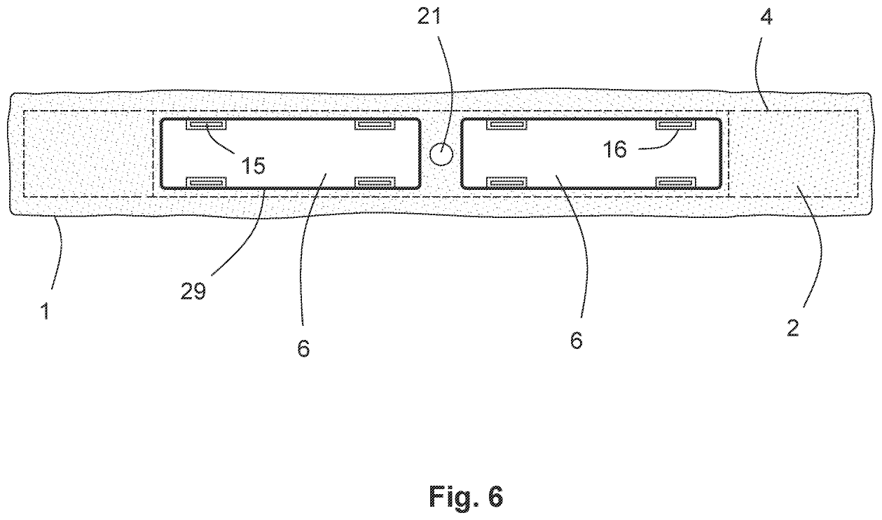

Moreover, FIGS. 4a and 6 show that the support frame 4 can have a central bore 21. The same applies for the clamping bar 9, wherein the central bore 21 is not apparent in FIG. 4b due to the central screw 23 that is attaching the clamping bar 9 so as to obscure the central bore 21 depicted in FIG. 4a. The central screw 23 preferably extends through the entire filter module 5 and is finally connected to the central pipe 7, and so the filter module 5 is fixed at the central pipe 7 via the central screw 23.

FIG. 4b also shows that it can be advantageous when the clamping bar 9 has a bulge 25 at one end and a corresponding recess 24 at the opposite end. If several such filter modules 5 are now mounted around a central pipe 7 in the circumferential direction in order to form a filter disk 17, each bulge 25 of a filter module 5 engages into the corresponding recess 24 of the adjacent filter module 5 similar to a tongue and groove fitted joint. In the end, the filter disk 17 formed in this way has a high mechanical stability.

FIG. 5 shows a cross-section of a filter module 5 according to an embodiment of the invention in the area facing away from the central pipe 7. The cut surface extends, with respect to FIG. 1, in a plane that passes through the axis of rotation of the central pipe 7 and extends radially with respect to the axis of rotation of the central pipe 7.

Two alternative possibilities are shown for providing the edge 8 of the filter bag 1 surrounding the mounting opening 3 with a reinforcement 26, which ensures a reliable and long-life fixation of the filter bag 1 with respect to the support frame 4. As is apparent from FIG. 5, the filter bag 1 has a reinforcement 26 on both sides (with respect to FIG. 5) in the vicinity of its edge 8 surrounding the mounting opening 3 (FIG. 3). The reinforcement 26 depicted on the right side of FIG. 5 is formed by a thick point of the filter material 2 itself. Depicted on the left side of FIG. 5 is a separate reinforcement 26 in which a wire 28 is present and embedded within the thick portion of the filter material 2. Preferably, the reinforcement 26 extends over the entire edge 8 surrounding the mounting opening 3. Alternatively, it is also possible that the reinforcement 26 is present only in the region of the edge 8 that extends in the longitudinal direction of the clamping bar 9.

Individual ribbings 13 can be present in the vicinity of the support element 4 as schematically shown in FIG. 5 in order to further increase the strength of the fixation of the filter bag 1 to the support frame 4. As a result of the presence of the ribbings 13, the static friction between the filter bag 1 and the support frame 4 is increased. Additionally, the strength of the fixation can be controlled according to the number and/or configuration of the ribbings 13.

Moreover, it is conceivable and also shown in FIG. 5 that the clamping bar 9 has multiple bolts 11, which extend into corresponding holding fixtures 12 that are defined in the support frame 4. More particularly, when the support frame 4 is composed of two half shells 10, these bolts 11 ensure that the half shells 10 are always correctly aligned with respect to each other.

The clamping bar 9 is fixed at the support frame 4 and pulled against the support frame 4 with the aid of multiple screws 22 as schematically shown in FIGS. 4b and 5 and corresponding nuts 27 as schematically shown in FIG. 5, and so the filter bag 1 is reliably pressed against the support frame 4 and fixed due to the resultant clamping effect.

Finally, FIG. 6 shows the area over which the filter module 5 rests against the central pipe 7. The filter bag 1 preferably has one or multiple seals 29 in order to ensure that the filter module 5 is reliably sealed with respect to the central pipe 7. In FIG. 6, the seals 29 each surround an exit opening 6, via which the filtrate can flow from the interior of the filter module 5 into the central pipe 7. The central bore 21 is also apparent between the two exit openings 6 in FIG. 6. The central screw 23 (not shown) can be inserted through the central bore 21 and connected to the central pipe 7 (not shown in FIG. 6).

Finally, in the exemplary embodiment of FIG. 6, the filter bag 1 has multiple tabs 16, which are slid over corresponding retaining extensions 15 of the support frame 4 when the filter module 5 is installed. As a result, the filter bag 1 is fixed in position with respect to the support frame 4, and so the filter bag 1 is prevented from being displaced with respect to the support frame 4 in the area of the outlet openings 6. The retaining extensions 15 are extensions that protrude upward through the tabs 16 in a direction that is perpendicular with respect to the sheet plane of FIG. 6, and so the tabs 16 cannot be shifted in the sheet plane.

The present invention is not limited to the represented and described exemplary embodiments. Modifications within the scope of the description, which includes the drawings and the claims, are also possible, as is any combination of the described features, even if they are represented and described in different parts of the written description, drawings or the claims or in different exemplary embodiments.

### LIST OF REFERENCE CHARACTERS

1 filter bag
2 filter material
3 mounting opening
4 support frame
5 filter module
6 exit opening
7 central pipe
8 edge
9 clamping bar
10 half shell
11 bolt
12 holding fixture
13 ribbing
14 honeycomb-shaped opening
15 retaining extension
16 tab
17 filter disk
18 opening
19 groove
20 bore
21 central bore
22 screw
23 central screw
24 recess
25 bulge
26 reinforcement
27 nut
28 wire
29 seal
30 thread

What is claimed is:

1. A filter bag for a rotary disk filter, which is configured to remove filtrate from wastewater and includes a plurality of filter modules, wherein each of the plurality of filter modules includes a support frame and defines an interior that is connected in communication with a hollow interior of a central pipe during rotating operation of the rotary disk filter, the filter bag comprising:
a filter material that defines a mounting end and an exit end spaced apart from and opposite the mounting end,
wherein the filter material defines an interior between the mounting end and the exit end,
wherein the filter material defines an edge that delimits a mounting opening at the mounting end of the filter material,
wherein the mounting opening is configured to be slipped over a support frame of the plurality of filter modules to form a filter module,
wherein the filter material defines an exit opening at the exit end of the filter material, wherein the exit opening is configured to allow the filtrate to exit the interior of the filter module into the hollow interior of the central pipe of the rotary disk filter, and
a reinforcement, which is connected to the filter material at the edge thereof, wherein the reinforcement is configured to fix the filter bag at the support frame.

2. The filter bag of claim 1, wherein the filter material is formed as pile cloth.

3. The filter bag of claim 1, wherein the mounting opening is formed essentially in the shape of a slit.

4. The filter bag of claim 1, wherein the reinforcement is formed by at least one elongate, preferably cable-shaped profile, for example, a wire, wherein the reinforcement is made more particularly of metal and/or plastic.

5. The filter bag of claim 1, wherein the reinforcement is connected to the filter material with the aid of one or multiple seam(s).

6. The filter bag of claim 1, wherein the reinforcement is at least partially encased in the filter material, for example, by a tube-like section of the filter bag, more particularly by a tube-like section of the filter material.

7. The filter bag of claim 1, wherein the filter bag has a seal in the area of the exit opening, via which the filter bag sealingly rests against a central pipe of the rotary disk filter during use as intended.

8. A filter module for a rotary disk filter, which is configured to remove filtrate from wastewater, the filter module comprising:
a support frame and a filter bag, which encloses at least a section of the support frame, wherein the filter bag includes:
a filter material that defines a mounting end and an exit end spaced apart from and opposite the mounting end,
wherein the filter material defines an interior between the mounting end and the exit end,
wherein the filter material defines an edge that delimits a mounting opening at the mounting end of the filter material,
wherein the mounting opening is configured to be slipped over a support frame of the plurality of filter modules to form a filter module,
wherein the filter material defines an exit opening at the exit end of the filter material, wherein the exit opening is configured to allow the filtrate to exit the interior of the filter module into the central pipe of the rotary disk filter, and
a reinforcement, which is connected to the filter material at the edge thereof, wherein the reinforcement is configured to fix the filter bag at the support frame.

9. The filter module of claim 8, further comprising a clamping bar that is configured and disposed to exert a clamping effect and retains the filter bag pressed to the support frame at the mounting opening.

10. The filter module of claim 8, wherein the support frame is defined by a pair of half shells.

11. The filter module of claim 10, wherein each of the half shells of the pair of half shells defines a plurality of the holding fixtures, and
wherein the clamping bar includes a plurality of bolts, wherein each of the plurality of bolts penetrates the filter material and engages respective holding fixtures of the pair of half shells.

12. The filter module of claim 9, wherein the support frame and/or the clamping bar have/has an uneven surface that defines a ribbing, which is in contact with the filter bag in order to intensify the clamping effect of the clamping bar in comparison to an even surface.

13. The filter module of claim 8, wherein the support frame has a plurality of honeycomb-shaped openings, through which the filtrate passing through the filter material can flow into the interior of the filter module.

14. The filter module of claim 8, wherein the filter bag defines holes or tabs and the support frame includes retaining extensions in the form of hooks, which engage into or extend through holes or tabs of the filter bag.

15. A rotary disk filter comprising:
a central pipe extending along a longitudinal direction;
a plurality of filter disks, which are arranged adjacent to one another in the longitudinal direction of the central pipe and connected to the central pipe, wherein each filter disk includes a plurality of filter modules, which are arranged adjacent to one another in the circumferential direction with respect to the longitudinal direction of the central pipe, wherein each of the plurality of the filter modules includes:
a support frame and a filter bag, which encloses at least a section of the support frame, wherein the filter bag includes:
a filter material that defines a mounting end and an exit end spaced apart from and opposite the mounting end,
wherein the filter material defines an interior between the mounting end and the exit end,
wherein the filter material defines an edge that delimits a mounting opening at the mounting end of the filter material,
wherein the mounting opening is configured to be slipped over a support frame of the plurality of filter modules to form a filter module,
wherein the filter material defines an exit opening at the exit end of the filter material, wherein the exit opening is configured to allow the filtrate to exit the interior of the filter module into the central pipe of the rotary disk filter, and
a reinforcement, which is connected to the filter material at the edge thereof, wherein the reinforcement is configured to fix the filter bag at the support frame.

16. The rotary disk filter of claim 15, wherein the central pipe has a plurality of openings, via which the filtrate can flow from the filter modules into the interior of the central pipe, wherein each filter module has a plurality of retaining extensions, each of which protrudes into a respective one of the plurality of openings of the central pipe and prevents the filter module from slipping with respect to the central pipe.

17. The filter module of claim 9, wherein the support frame is defined by a pair of mirror symmetrical, half shells.
